(19) United States
(12) Patent Application Publication
(10) Pub. No.: US 2019/0274420 A1
(43) Pub. Date: Sep. 12, 2019

(54) MAKEUP APPLICATOR CASE HAVING UV LIGHT DISINFECTION SYSTEM

(71) Applicant: Ritta Zeilah, McLean, VA (US)

(72) Inventor: Ritta Zeilah, McLean, VA (US)

(21) Appl. No.: 15/917,571

(22) Filed: Mar. 10, 2018

(51) Int. Cl. A46B 17/04; A46B 17/06; F26B 5/00

(52) U.S. Cl. CPC A46B 17/04; F26B 5/00; A46B 17/065

(57) ABSTRACT

Disclosed herein are cosmetic brush cases and sponge cases having an ultraviolet light disinfection a functional interior section with a plurality of vent openings designed for airing and protecting a plurality of bristles of a makeup brush or makeup sponge. The cases are configured in such a way for both sections of the body to unite to provide a container for the head of the brush or for a sponge.

### RELATED APPLICATIONS

This application claims the benefit of U.S. Provisional Application No. 62/484,027, entitled “Makeup Applicator Case Having UV Light Disinfection System” and filed on Apr. 11, 2017, which is incorporated herein by reference in its entirety.

### FIELD

Some implementations relate generally to a case for storing makeup applicators such as brushes and sponges, and more specifically, to a makeup brush or makeup sponge case having vent openings for active distribution of air to the interior of the case and an ultraviolet light (UV) source providing UV light to dry and disinfect the bristles of a makeup brush and/or a makeup sponge.

### BACKGROUND

Makeup applicators are used to apply makeup, such as foundation or various other powder forms of cosmetics, and come in a wide variety of shapes, sizes, and configurations. Examples of applicators are a makeup brush and a makeup sponge. These applicators typically come packaged in a plastic case to enclose the bristles of the makeup brush to prevent damage to the bristles prior to sale of the brush. Before use, the plastic case is discarded as it is generally unsuitable for later protecting the bristles of the makeup brush. The plastic case is generally a low quality material that tightly binds the bristles of the brush during transport and prior to sale. The included plastic case is unsuitable to store the makeup brush after the initial use because it is very difficult to reattach the plastic case, which also compresses the bristles of the makeup brush.

These makeup products have exterior surfaces that can harbor pathogens, such as bacteria and molds. These pathogens, although typically quite benign at low levels, can multiply rapidly to cause acne growth on to a makeup user's skin.

Makeup applicators, such as brushes and sponges, have been washed with soap, clean or sterilized water, and a common method for the sterilization or disinfection of the water involved directing UV light into it. However, the brushes and scrubbers employed for water application can themselves become contaminated and spread pathogens to entire lots of the makeup applicator. Some implementations of the disclosed subject matter disinfect the makeup applicator without contacting it with a potentially contaminated brush or applicator.

Additionally, the exterior surfaces of a packaged product, such as plastic containers, cups, caps, films and foils have all been directly disinfected with UV light on a bulk or mass manufacturing level. Because makeup applicators are typically round and opaque, they are prevented them from receiving total surface illumination from a single, stationary source of UV light.

Oftentimes makeup or stray items are also stored in the purse or bag. This damage could result in loosening of bristles, bending or breakage of bristles, non-uniformity of bristles, and the like. In other cases, the damage could come from products inadvertently spilt in the purse or bag that then come in contact with the bristles of the brush.

Previous solutions for storing and transporting a makeup brush require the user to place the makeup brush in a larger makeup bag, or re-sealable plastic bag, and place this large bag inside of a purse or other carrying bag. This method is generally cumbersome and undesirable because it consumes too much space within the purse or bag. Additionally, the makeup contained on the bristles may stain the area of storage. If the brush is simply placed in a purse, or other article, the brush and/or article is likely to become damaged or stained.

Other solutions for storing and transporting a makeup brush include a closed case with no vent openings which do not permit air to circulate within the case allowing brush bristles to dry after use and/or wash thus encourage growth of bacteria or other unsanitary conditions because of the tendency of bacteria to grow in a moist atmosphere. Either solution exposes the user's hygiene at risk of applying bacteria collected in the bristles of the brush to the user's skin.

Disinfection with ultraviolet (UV) light can dramatically increase the shelf life of many manufactured products. Extending shelf life by a safe and relatively inexpensive process allows the manufacturers of these products to reduce the use of chemical preservatives and disinfectants. UV light disinfection systems offer the advantage of lower disinfecting costs as compared with conventional brush or sponge cleaning chemical additives and cleaning agents. UV light disinfection systems are utilized in many industries as an environmentally safe and regulation free method of sterilization. Additionally, UV disinfection systems are free from consumer or environmental concerns that are often voiced regarding conventional chemical disinfection methods. UV disinfection systems have been used successfully in many drinking and process water applications, and in hospitals, pharmaceutical and beverage production.

### SUMMARY

Some implementations of the disclosed subject matter include an ultraviolet light disinfection method and makeup case apparatus. Some implementations include an ultra violet light source that provides a disinfecting illumination of a wet and dry makeup applicator within a storage case. A makeup applicator case can be utilized to store the makeup applicator and hold makeup applicators into proximity of the ultraviolet light source. A makeup applicator can be designed for portability and stored in the case with vent openings enabling natural convection to allow stagnant air to pass through the case.

To better respond to makeup products of varying height and size, the ultraviolet light sterilization apparatus can include humidity level sensors. Humidity level sensors maintain the ultraviolet light source at a preselected level of separation between the makeup applicator and the ultraviolet light source. The humidity level sensor is responsive to detect the intensity or power required to achieve a desired level of surface disinfection and drying for a particular makeup applicator.

The method of the present disclosure includes first positioning the makeup applicator into proximity of an ultraviolet light source. The ultraviolet light source illuminates the exterior surface of the makeup applicator.

According to one aspect of the disclosed subject matter, a makeup applicator is disinfected by direct exposure to ultraviolet light. Conventional disinfecting methods for makeup applicator, such as makeup brushes and sponges consisted of washing the makeup applicator with soap, sterilized or disinfected water, rather than direct ultraviolet disinfection.

According to a related advantage of the disclosed subject matter, ultraviolet light is employed to disinfect, or alternatively sterilize, the surface of a makeup applicator without the use of water or potentially contaminated brushes.

According to another aspect of the disclosed subject matter, the makeup applicator is disinfected over its entire surface.

According to yet another aspect of the disclosed subject matter, makeup applicator of various sizes can be adequately disinfected.

Benefits of using the makeup applicator case include killing bacteria living on the makeup bristles or sponge, preventing the bristles and the sponge from being damaged during storage, thus, extending the life of the makeup brush or sponge. A plurality of openings is located on the body member to allow air to circulate in a free convective flow or forced convective flow within the case so that it may dry a wet brush or sponge.

The user will be able to store a used or washed brush allowing less downtime in-between uses waiting for brush to dry. The light emitting diodes provided by the sensors along the interior of the case will provide a sanitary means for storing and drying the makeup brush and sponge after usage. Wet makeup brush bristles and facial sponge can become harmful to the user if not properly dried after usage, as this encourages the growth of mold and bacteria. The bacteria and fungi that build up on the sponge can spread onto the user's skin causing a number of problems such as infection, redness, swelling, and even breakouts. Thus, if a makeup brush is used and/or washed and stored damp, it can dry out to provide better sanitary solutions for the user.

### BRIEF DESCRIPTION OF THE DRAWINGS

Some implementations of the disclosed subject matter can be understood from the following description taken in conjunction with the accompanying drawings, in which like reference numerals identify the same elements. The drawings and detailed description which follow are intended to be merely illustrative and are not intended to limit the scope of the disclosed subject matter. The disclosed subject matter, as well as a preferred mode of use, and advantages thereof, will best be understood by reference to the following detailed description of illustrated embodiments when read in conjunction with the accompanying drawings.

FIG. 1 is an elevated view of an example makeup applicator case in a closed position covering the bristles of a makeup brush.

FIG. 2 is an elevated view of the makeup applicator case in an open position covering the bristles of a makeup brush.

FIG. 3 is an elevated view of the makeup applicator case in a closed position covering the bristles of a makeup brush.

FIG. 4 is a bottom perspective view of the makeup applicator case in an open position.

FIG. 5 is a top view of the makeup applicator case for a makeup brush in a closed position.

FIG. 6 is an elevated view of an alternative version of a makeup applicator case for a makeup sponge in a closed position.

FIG. 7 is an elevated view of an alternative version of a makeup applicator case for a makeup sponge of the in a closed position holding the makeup sponge.

FIG. 8 is an elevated perspective view of an alternative version of a makeup applicator case for a makeup sponge in an open position.

FIG. 9 is a bottom view of an alternative version of a makeup applicator case for a makeup sponge in an open position.

FIG. 10 is a top view of an alternative version of a makeup applicator case for a makeup sponge in an open position.

### DETAILED DESCRIPTION

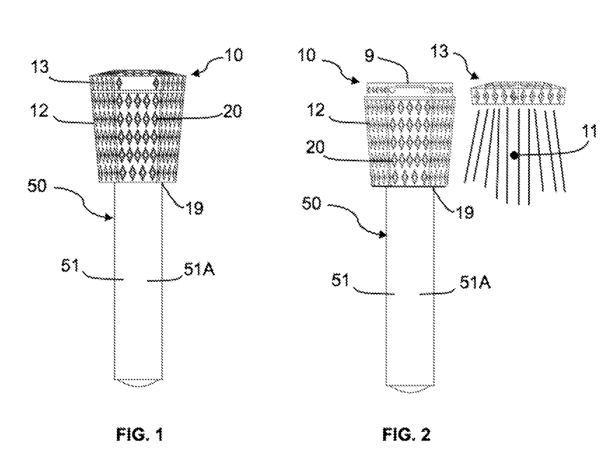

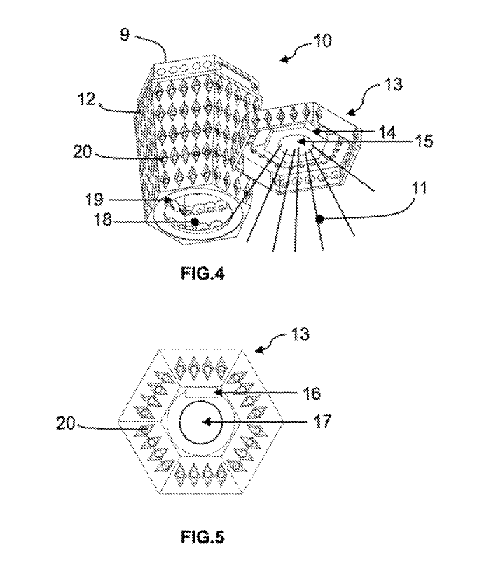

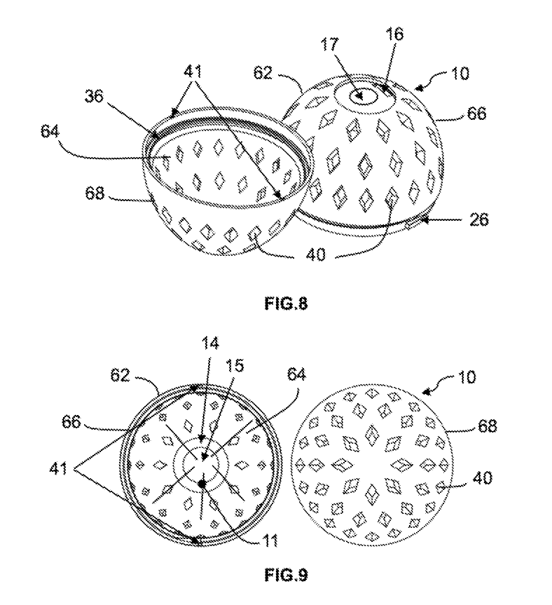

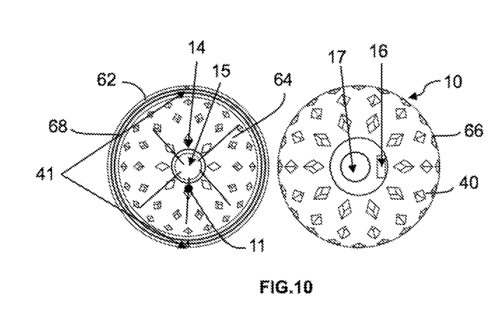

Referring to FIGS. 1-10, some implementations provide an ultraviolet light disinfection apparatus (10), which is specifically configured to dry and disinfect the bristles (29) or sponge (70) of a makeup applicator (50). As detailed in FIG. 4, FIG. 9 and FIG. 10 the ultraviolet light disinfection apparatus includes an ultraviolet light source (15) positioned in the interior section of a makeup applicator case (10).

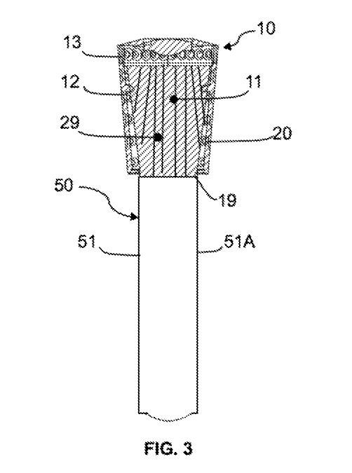

A makeup applicator case (10) presents a makeup applicator bristles (29) or sponge (70) to the ultraviolet light source (15). In a preferred embodiment, makeup brushes (51) and sponges (70) are preferred makeup applicators (50) conveyed beneath an ultraviolet light (11) emitted by the ultraviolet light source (15), as illustrated in FIG. 3 and FIG. 7. However, as discussed further herein, a wide variety of makeup applicators can be successfully processed with an implementation of the disclosed subject matter.

For the purposes of this detailed description, the term “ultraviolet” will be hereinafter abbreviated to UV. In a preferred embodiment, a single UV light source (15) can be employed, depending on the requirements of a particular configuration of makeup applicator bristles (29), sponge (70) and UV light source. Alternatively, the UV light source (15) may include a first UV light source paired with a second UV light source to fully illuminate the makeup applicator bristles (29) or sponge (70) with the UV light (11). This paired configuration, the first UV light source and the second UV light source may be needed to provide adequate UV light coverage for the entire width of the makeup applicator bristles (29) or sponge (70). Any UV disinfection device manufactured by any manufacturer can be utilized.

Determining the required intensity or power of the UV light source (15) is first based upon the dosage of the UV light (11) required to achieve a desired level of surface disinfection and drying for a particular makeup applicator (50). Some implementations are tailored to disinfect and dry the bristles (29) of a makeup brush (51) or sponge (70). Makeup applicators (50) are herein defined as a makeup brush (51), sponge (70), silicone or any material used to apply makeup to a user's skin.

Some implementations efficiently disinfect the exterior surface of the bristles (29) or sponge (70) of the makeup applicator (50) with a disinfecting illumination that employs efficient and an environmentally safe UV light (11). By utilizing the makeup applicator case (10) to store the makeup applicator (50), the makeup applicator case (10) holds the makeup applicator bristles (29) or sponge (70) in the proximity of the UV light source.

Referring to FIGS. 1-5, a version of the makeup applicator case (10) (hereinafter case 10) is shown. This version is a makeup applicator case (10) for a makeup applicator (50) as a makeup brush (51). The makeup applicator case (10) is comprised of a body member (12) and a lid (13). The case may be of various sizes or shapes. The body member (12) and lid (13) are made from a rigid material such as a plastic. However, any suitable material may be used. The body member (12) can be formed to correspond to a shape of a makeup brush or other makeup applicator, which can include one of a generally rectangle shape, a generally round shape, a generally cone shape, a generally cylindrical shape, a generally triangle shape, and a generally square shape.

The body member (12) includes a top opening (9), and bottom opening (19) that may be configured to receive the bristles (29) of a makeup brush (51). At the top section of the body member (12), a larger opening (9) is formed. On the bottom section of the body member (12), a smaller opening (19) is formed. The makeup brush (51) may be inserted from the top opening (9) with the makeup brush handle (51A) inserted first through the bottom opening (19). The opening (19) is used to allow the handle (51A) of the makeup brush (51) to protrude out of the case (10).

The shape of the body member (12) may be generally rectangle. In other versions, the shape of the body member (12) may be round shaped, cone shaped, cylindrical shaped, triangle shaped, square shaped, or any other suitable shape for receiving brush (51) so as to minimize compressing bristles (29) of brush (51).

One may open the body member (12) to expose a hollow interior section (18). The interior section (18) is where the bristles (29) of the makeup brush (51) will be stored. The lid (13) can be detached from the body member (12) or permanently coupled together by any method such as a hinge. Thus, by removing the lid (13) from the body member (12), one will expose the functional interior section (18). By opening the body member (12), one can easily position the bristles (29) of the makeup brush (51) within the case (10).

The top and bottom surfaces of the body member (12) will have a plurality of vent openings (20). The vent openings (20) will allow air to circulate within the case (10). The air will allow the bristles (29) of the makeup brush (51) to dry more quickly after being used and/or washed. Further, the UV light (15) will allow the bristles (29) of the makeup brush (51) to sanitize against germs and bacteria after being used and/or washed. The air circulation will further prevent mold and mildew from forming inside the case (10) since the air circulation will allow the bristles to dry after being used and/or cleaned.

The case (10) has a locking mechanism located on the lid (13) and the body member (12). The locking mechanism will lock the body member (12) together in order to securely hold the makeup brush (51) in the case (10). One may remove the lid (13) from the body member (12) to expose the housing (14) for a UV light control board, sensors and a rechargeable battery located at the bottom of the lid (13). A sanitizing UV light source (15) is positioned in the housing (14). The top of the lid (13) comprises a Universal Serial Bus (USB) interface (16) and a button (17). The bottom of the lid (13) comprises a UV light source (15) and a housing (14) for sensors, the UV light control board and a rechargeable battery.

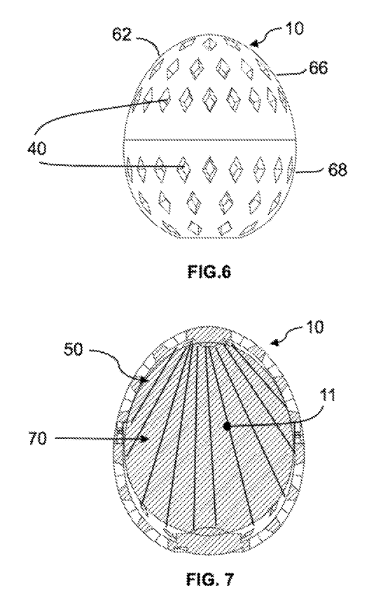

Referring to FIGS. 6-10, an alternative version of a makeup applicator case (10) (hereinafter case 10) is shown. This version is a makeup applicator case (10) for another makeup applicator (50) as a makeup sponge (70). The makeup applicator case (10) is comprised of a body member (62). The case may be of various sizes or shape. The body member (62) is made from a rigid material such as a plastic. However, any suitable material may be used.

The body member (62) may be configured to receive a makeup sponge (70). The shape of the body member (62) may be generally oval. In other versions, the shape of the body member (62) may be round shaped, cone shaped or cylindrical shaped, triangle shaped, square shaped, rectangular shaped or any other suitable shape for receiving a sponge (70) so as to minimize compressing the sponge (70).

One may open the body member (62) to expose a hollow interior section (64). The interior section (64) is where the makeup sponge (70) will be stored. A first side (66) of the body member (62) may be removably coupled together to the second side (68) of the body member (62). The first side (66) and second side (68) of the body member (62) is fastened together using a thread pattern (36). The locking mechanism (26) will fasten the body member (62) together using a thread pattern (36) together in order to securely hold the makeup sponge (70) in the case (10). Locking mechanism (26) can also include a button actuated mechanical latching mechanism or a magnetic latching mechanism. Thus, by unfastening the body member (62) apart so that first side (66) is separated from the second side (68), one will expose the functional interior section (64). By opening the body member (62), one can easily position the sponge (70) within the case (10).

One may remove the first side (66) from the body member (62) to expose the housing (14) for a UV light control board, sensors and a rechargeable battery inside the first side (66). Additionally, one may remove the second side (68) from the body member (62) to expose the housing (14) for a UV light control board, sensors and a rechargeable battery inside the second side (68). The case (10) has metal contacts located on the first side (66) and second side (68) of the case (10). Thus, when the metal contacts (41) are coupled together on the first side (66) with the second side (68), low voltage flows to the top and enable power for the UV light (11) to turn on. A sanitizing UV light (15) is positioned in the housing (14). The exterior of the first side (66) comprises a Universal Serial Bus (USB) interface (16) and a button (17). The interior section (64) of the first side (66) comprises the UV light bulb (15) and a housing (14) for sensors, the UV light control board and a rechargeable battery. The interior section (64) of the second side (68) comprises the UV light bulb (15) and a housing (14) for sensors, the UV light control board and a rechargeable battery.

The first side (66) of the body member (62) will have a plurality of vent openings (40). The vent openings (40) will allow air to circulate within the case (10). The air will allow the sponge (70) to dry more quickly after being used and/or washed. The air circulation will further prevent mold and mildew from forming inside the case (10) since the air circulation will allow the sponge (70) to dry after being used and/or cleaned.

Within the hollow interior section (64) of the first side (66) of the body member (62), the interior may be shaped to allow room to store approximately the first half of a makeup sponge (70). Within the hollow interior section (64) of the second side (68) of the body member (62), the interior (64) may be shaped to allow room to store approximately the second half of a makeup sponge (70). Thus, when the first side (66) and the second side (68) are attached, both sides will align with each other to form the body member (62) with the makeup sponge (70) encased.

Referring to FIGS. 1-10, the USB interface (16) is for providing power to the makeup applicator case (10). The rechargeable battery is for providing voltage to the makeup applicator case (10). When the USB interface (16) is connected to an external USB device with a power source (i.e. computer), the power charging and register circuit receives voltage from the USB interface (16), charges the rechargeable battery, and converts the voltage required to provide power for the makeup applicator case (10). Further, when the USB interface (16) is connected to an external USB device with a computer, the user may customize the settings for the UV light source (15). Settings comprise, but are not limited to, controlling the auto on or off function depending on the humidity level, a timer or scheduled time. Settings may also comprise configuring the intensity levels to emit UV light (115).

The user may press the button (17) to use any of the settings programmed by the USB interface (16) depending on the number of times the button (17) is selected or how long the button (17) is pressed down. The user may switch through the on or off function of the auto-shut off timer or the intensity level of emitting UV light (11). The button (17) can also turn the UV light to either off or on.

The housing (14) may contain one or more sensors to detect the humidity level in the case. The one or more sensors utilized in the makeup applicator case include one or more sensor input elements and can optionally include one or more sensor output elements associated therewith. The term “sensor” refers to a device, component, or assembly that detects a condition, marker, or stimulus, typically found within the makeup applicator case although the detection may occur outside of the makeup applicator case. The sensor output element may provide a dual function, such as functioning as a sensor output element and providing a responsive output.

The detection can occur upon activation of pressing the programmable button (17) on the lid (13). Activation of the makeup applicator case (10) can comprise, for example, pressing the programmable button (17) on the makeup applicator case (10) on to emit UV light (11) to the makeup brush bristles (29) or sponge (70). Generally, the sensors as used herein provide a signal that provides information as to the detected condition, marker, or stimulus. The sensors of the present may be electrically powered and are therefore in electrical communication with a power source, such as one or more disposable or rechargeable batteries.

A UV light (11) is used in combination with a sensor input element to detect bacteria and then the light source could provide a responsive output (e.g., changing the power output to kill the bacteria) in response to the detection of bacteria or humidity level in the case by the sensor input element. Sensors can also provide the user with a variety of other information, such as, sensing and alerting a user when a treatment session is complete, when the makeup applicator is properly positioned, when the makeup applicator is in contact with the interior walls of the makeup applicator case (10), and/or if the temperature or humidity level in the treatment area rises above a predetermined level. Sensors can also be used with a controller to provide automatic feedback control of a treatment session(s). The UV light (11), sensor input and sensor output elements can be positioned anywhere on the makeup applicator case (10), such as throughout the walls of the interior section (18) (64).

Some implementations relate generally to a case for storing makeup applicators, and more specifically, to a makeup brush or sponge case having vent openings for active distribution of air to the interior of the case while also using UV light to dry and disinfect the bristles of a makeup brush. The ventilated case may store any makeup brush of any shape, form or bristle material. Further, the ventilated case may store any makeup sponge of any shape, form or sponge material.

Another variation of the case described herein may be configured to use an inner ribbed lining. The interior section is where the bristles of the makeup brush will be stored. In its interior case comprises an inner ribbed lining extending substantially the entire length thereof and which, form a restricted channel adapted to fit snugly around the bristles of the makeup brush. The inner ribbed lining is spaced apart just sufficiently so that no part of the protruding bristles touches the adjacent case and also to allow circulation of air around the bristles so that these may dry out when the brush is not in use.

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the to be appended claims shall allow for the inclusion of any additional element irrespective of whether a given number of elements are enumerated in the to be appended claim, or the addition of a feature could be regarded as transforming the nature of an element set forth in the to be appended claims. Except as specifically defined herein, all technical and scientific terms used herein are to be given as broad a commonly understood meaning as possible while maintaining to be appended claim validity.

The breadth of the present disclosure is not to be limited to the examples provided and/or the subject specification. Further, it is not intended that any section of this specification (e.g., the Summary, Detailed Description, Abstract, Field, etc.) be accorded special significance in describing the disclosed subject matter. Although the foregoing implementations have been described in detail for purposes of clarity of understanding, it is contemplated that certain modifications may be practiced within the scope of the disclosed subject matter.

1. A makeup brush cover configured with a hollow interior space to receive and hold bristles of a makeup brush when the makeup brush is stored in the makeup brush cover, the makeup brush cover comprising:
a body member having a top opening and a bottom opening;
a plurality of vent openings disposed in the body member; and
a lid configured to fit into the top opening and having an ultraviolet light source, an ultraviolet light control board connected to the ultraviolet light source, a rechargeable battery connected to the ultraviolet light control board, an interface connected to the ultraviolet light control board, a button connected to the ultraviolet light control board, and one or more sensors.

2. The makeup brush cover of claim 1, wherein the body member is formed from one or more of a flexible material or a rigid material.

3. The makeup brush cover of claim 2, wherein the rigid material is one or more of plastic, metal, wood, glass, stone, fiber, clay, natural, synthetic or composite material.

4. The makeup brush cover of claim 1, wherein the body member is formed to correspond to a shape of a makeup brush, which includes one of a generally rectangular shape, a generally round shape, a generally conical shape, a generally cylindrical shape, a generally triangular shape, or a generally square shape.

5. The makeup brush cover of claim 1, wherein the interface includes one of a universal serial bus interface, a USB port, or a HDMI port.

6. The makeup brush cover of claim 1, further comprising a locking mechanism to lock the lid and the body member together in order to securely hold the makeup brush in the makeup brush cover.

7. The makeup brush cover of claim 1, wherein the lid is removably attached to the top opening.

8. The makeup brush cover of claim 1, wherein the body member includes protrusions configured to permit the makeup brush cover to rest on the protrusions when placed on a surface.

9. The makeup brush cover of claim 6, wherein the locking mechanism includes a magnetic locking member or a button actuated mechanical latching mechanism.

10. A makeup applicator case comprising:
a body member having a top opening and a bottom opening; and
a lid configured to fit into the top opening and having an ultraviolet light source, an ultraviolet light control board connected to the ultraviolet light source, an interface connected to the ultraviolet light control board, and a button connected to the ultraviolet light control board, and one or more sensors connected to the ultraviolet light control board.

11. The makeup applicator case of claim 10, wherein the body member is formed from one or more of a flexible material or a rigid material.

12. The makeup applicator case of claim 11, wherein the rigid material is one or more of plastic, metal, wood, glass, stone, fiber, clay, natural, synthetic or composite material.

13. The makeup applicator case of claim 10, wherein the body member is formed to correspond to a shape of a makeup applicator, which includes one of a generally rectangular shape, a generally round shape, a generally conical shape, a generally cylindrical shape, a generally triangular shape, or a generally square shape.

14. The makeup applicator case of claim 10, wherein the interface includes one of a universal serial bus interface, a USB port, or a HDMI port.

15. The makeup applicator case of claim 10, further comprising a locking mechanism to lock the lid and the body member together in order to securely hold a makeup applicator in the makeup applicator case.

16. The makeup applicator case of claim 10, wherein the lid is attached to the top opening.

17. The makeup applicator case of claim 10, wherein the body member includes protrusions configured to permit the makeup applicator case to rest on the protrusions when placed on a surface.

18. The makeup applicator case of claim 15, wherein the locking mechanism includes a magnetic locking member or a button actuated mechanical latching mechanism.

19. (canceled)

20. (canceled)

21. A makeup applicator case comprising:
a body member having a first side, a second side, and a top opening on the first side;
a first set of conductive contacts on the first side and a second set of conductive contacts on the second side, wherein the first set of conductive contacts couple with the second set of conductive contacts when the makeup applicator case is in a closed position; and
a lid configured to fit into the top opening and having an ultraviolet light source, an ultraviolet light control board connected to the ultraviolet light source, an interface connected to the ultraviolet light control board, and one or more sensors connected to the ultraviolet light control board.

22. The makeup applicator case of claim 21, wherein the one or more sensors detect one or more of a condition, a marker, or a stimulus within the makeup applicator case, wherein the detection occurs in one or more of inside or outside of the makeup applicator case, wherein the one or more sensors include one or more of one or more sensor input elements or one or more sensor output elements, and wherein the one or more sensors are connected to a controller to provide automatic feedback to the ultraviolet light control board.
